(19) United States
(12) Patent Application Publication
(10) Pub. No.: US 2024/0363870 A1
(43) Pub. Date: Oct. 31, 2024

(54) THICK FILM ELECTRODE AND MANUFACTURING METHOD THEREOF

(71) Applicant: UIF (UNIVERSITY INDUSTRY FOUNDATION), YONSEI UNIVERSITY, Seoul (KR)

(72) Inventors: Sang-Young LEE, Seoul (KR); Jung-Hui KIM, Seoul (KR)

(73) Assignee: UIF (UNIVERSITY INDUSTRY FOUNDATION), YONSEI UNIVERSITY, Seoul (KR)

(21) Appl. No.: 18/646,044

(22) Filed: Apr. 25, 2024

(30) Foreign Application Priority Data
Apr. 28, 2023 (KR) 10-2023-0056053

(51) Int. Cl. H01M 4/66; H01M 4/02; H01M 4/04; H01M 4/74

(52) U.S. Cl. CPC H01M 4/668; H01M 4/0404; H01M 4/0452; H01M 4/74; H01M 2004/021

(57) ABSTRACT

The present disclosure relates to a thick film electrode and a method for manufacturing the same. Since the thick film electrode uses a photocurable monomer as a processing solvent, it requires no separate drying step and may have a sufficiently large thickness without physical cracking. In addition, since the thick film electrode uses a nonwoven web-type substrate having a carbon body applied to the surface of a conductive polymer, it may have higher ion conductivity and areal capacity. Further, a semi solid-state battery including the thick film electrode may have excellent energy density.

### CROSS-REFERENCE TO RELATED APPLICATION

This application claims priority to Korean Patent Application No. 10-2023-0056053 filed on Apr. 28, 2023, and all the benefits accruing therefrom under 35 U.S.C. § 119, the contents of which in its entirety are herein incorporated by reference.

### BACKGROUND

### 1. Field

The present disclosure relates to a thick film electrode and a method for manufacturing the same.

### 2. Description of the Related Art

As the performance of electronic instruments has been developed rapidly, development of high-performance secondary batteries used for operating the electronic instruments has been increasingly in demand. Typically, there is an imminent need for securing high-energy density batteries capable of realizing higher energy at the same weight. For this purpose, many domestic and foreign researchers have developed novel electrode active materials having high energy density, but application of such novel electrode active materials to actual secondary batteries requires a lot of time and effort.

As a method for using the existing electrode active materials without developing novel materials, a method of increasing the thickness of the active material coating layer of an electrode may be used. For example, when substituting eight sheets of the existing electrodes having a thickness of 25 μm with one sheet of thick film electrode having a thickness of 200 μm, it is possible to reduce the weight and volume of a battery by 30% or more, which helps improvement of the energy density of the battery.

However, there is a problem to be solved in order to commercially apply such a thick film electrode. First, although the method for manufacturing an electrode according to the related art uses a processing solvent, the processing solvent causes non-uniform localization of a conductive material/binder during a drying step. This causes generation of physical cracking and degradation of electrical conductivity, thereby causing a problem in that uniform thick film formation is difficult.

In addition, electron and ion migration is difficult in a thick film electrode, resulting in significant degradation of electrochemical characteristics. As a solution for this, various attempts, including introduction of a novel electrode structure, have been reported. However, such attempts require a complicated and expensive processing step, which rather causes a problem in that commercialization possibility of the thick film electrode is lowered.

Therefore, in order to solve the above-mentioned problems, there is an imminent need for studying a thick film electrode which is effectively prevented from cracking during the manufacturing process, has excellent chemical stability and shows excellent ion conductivity.

### SUMMARY

To solve the above-mentioned problems, the present disclosure is directed to providing a thick film electrode which is effectively prevented from cracking during the manufacturing process, has excellent chemical stability and shows excellent ion conductivity.

The present disclosure is also directed to providing a high-energy density semi solid-state battery including the thick film electrode.

Under these circumstances, the present inventors have conducted intensive studies to provide a thick film electrode which is effectively prevented from cracking, has excellent chemical stability and shows excellent ion conductivity. As a result, we have found that a thick film electrode obtained by successively stacking a nonwoven web-type polymer substrate having a carbon body bound to the surface thereof and an electrode active layer containing a polymer electrolyte, requires no separate drying step and thus causes no cracking and shows uniform and excellent ion conductivity and excellent areal capacity, and a battery including the thick film electrode has high energy density. The present disclosure is based on this finding.

In one aspect, there is provided a thick film electrode including: a nonwoven web-type polymer substrate having a carbon body bound to the surface thereof; and an electrode active layer on the polymer substrate.

According to an embodiment of the present disclosure, the carbon body may be bound to the polymer substrate by IT electron interaction.

According to an embodiment of the present disclosure, the carbon body may be single-walled carbon nanotubes (SWCNTs).

According to an embodiment of the present disclosure, the polymer substrate may have a semi-interpenetrating polymer (IPN) network structure.

According to an embodiment of the present disclosure, the electrode active layer may contain a crosslinked polymer derived from a multifunctional monomer, an electrolyte, an active material and a conductive material.

According to an embodiment of the present disclosure, the crosslinked polymer may be present in an amount of 0.1-20 parts by weight based on 100 parts by weight of the active material.

According to an embodiment of the present disclosure, the polymer substrate may include a polyetherimide-based polymer and a crosslinked polymer derived from a multifunctional monomer.

According to an embodiment of the present disclosure, the weight ratio of the polyetherimide-based polymer to the crosslinked polymer may satisfy 1-10:1.

According to an embodiment of the present disclosure, the polymer substrate may have a thickness of 1-100 μm.

According to an embodiment of the present disclosure, the thick film electrode may have a structure in which at least two unit electrode active layers including a polymer substrate and an electrode active layer on the polymer substrate are stacked in the thickness direction.

According to an embodiment of the present disclosure, the thick film electrode may have a weight of active material per unit area of 40-80 mg/cm².

According to an embodiment of the present disclosure, the thick film electrode may have a thickness of 100-500 μm.

In another aspect, there is provided a method for manufacturing a thick film electrode, including the steps of: (S1) preparing a nonwoven web-type polymer substrate having a carbon body bound to the surface thereof; and (S2) applying a slurry composition containing a multifunctional monomer, an electrolyte, an active material and a conductive material onto the polymer substrate, followed by curing, to form an electrode active layer.

According to an embodiment of the present disclosure, step (S1) may include the steps of: (a) electrospinning a mixed polymer solution including a polyetherimide-based polymer and a multifunctional monomer-containing polymer; and (b) electrospraying a carbon body dispersion.

According to an embodiment of the present disclosure, the multifunctional monomer may be a monomer containing at least two photocurable functional groups.

According to an embodiment of the present disclosure, the method may further include repeating a unit process including steps (S1) and (S2) at least once.

Since the thick film electrode according to an embodiment of the present disclosure uses a photocurable monomer as a processing solvent, it requires no separate drying step and may have a sufficiently large thickness without physical cracking. In addition, since the thick film electrode according to an embodiment of the present disclosure uses a nonwoven web-type substrate having a carbon body applied to the surface of a conductive polymer, it may have higher ion conductivity. Further, a semi solid-state battery including the thick film electrode may have excellent energy density.

### BRIEF DESCRIPTION OF THE DRAWINGS

FIG. 1 is a schematic view illustrating the approximate process of a preparation example of the present disclosure.

FIGS. 2A to 2D are scanning electron microscopic (SEM) images illustrating the surface of the nonwoven web-type polymer substrate prepared according to a preparation example of the present disclosure as analyzed by S-4800 (Hitachi).

FIG. 3 is a schematic view illustrating the approximate process of an example of the present disclosure.

FIG. 4 shows an image of the thick film electrode obtained according to a preparation example of the present disclosure and a sectional SEM image of the thick film electrode.

FIG. 5 is a schematic view illustrating the approximate process of Comparative Example 1.

FIG. 6 is a graph illustrating the distribution of the conductive material in the thick film electrode according to each of Comparative Example 1 and Example 3 as visualized by using FIB 3D reconstruction (Image-Pro Premier 3D (Media Cybernetics)).

FIG. 7 shows a sectional SEM image of the thick film electrode according to each of Comparative Example 1 and Example 3 and a graph illustrating the localized charge transfer resistance (R_{l,ct}) of each thick film electrode as analyzed by localized electrochemical impedance spectroscopy (LEIS).

FIG. 8 is a charge/discharge profile graph illustrating the electrochemical characteristics of the coin cell obtained from Test Example 4 depending on various current conditions.

FIG. 9 is a graph illustrating the capacity per weight and coulombic efficiency of the coin cell obtained from Test Example 4 depending on charge/discharge cycle numbers.

FIG. 10 is a charge/discharge profile graph illustrating the electrochemical characteristics of the coin cell obtained by using the thick film electrode according to each of Examples 1-5 as a positive electrode, wherein the descending curve shows the discharge capacity and the ascending curve shows the charge capacity.

FIG. 11 is a charge/discharge profile graph illustrating the rate characteristics of the coin cell obtained by using the thick film electrode according to Example 1 as a positive electrode.

FIG. 12 is a graph illustrating the energy per weight, areal capacity and coulombic efficiency of the pouch-type cell obtained from Test Example 4 depending on charge/discharge cycle numbers.

### DETAILED DESCRIPTION

Unless otherwise stated, the terms used herein, including technical and scientific terms, have the same meanings as understood by those skilled in the art. The terms used herein are for the purpose of describing particular embodiments only and is not intended to be limiting of the present disclosure.

As used herein, the singular forms “a”, “an” and “the” are intended to include the plural forms as well, unless the context clearly indicates otherwise.

In addition, the numerical range used in the specification may include all possible combinations of lower and upper limits and all values within the range, logically derived increments in the form and width of the defined range, double-limited all values, and upper and lower limits of the numerical range limited to different forms. Values other than the numerical range that are likely to occur due to experimental errors or rounding of values are also included in the defined numerical range unless otherwise stated in the specification.

It will be further understood that the terms “include” and/or “comprise” used in this specification is an open description having the same meaning as “be provided with”, “contain”, “have” or “be characterized by” and do not preclude the presence of other elements, materials or steps not listed additionally.

As used herein, the term “wrapping” refers to surrounding of carbon nanotubes (CNTs) with a polymer by means of electrostatic interaction and may also cover the meaning of coating, application, binding and attachment. In addition, the electrostatic interaction may refer to π electron interaction (π-π stacking interaction).

Further, as used herein, the expression “one layer is disposed ‘on’ the other layer” covers not only a case in which one layer is in contact with the other layer but also a case in which one or more different layers are present between both layers.

Hereinafter, the thick film electrode according to an embodiment of the present disclosure will be explained in more detail.

In one aspect of the present disclosure, there is provided a thick film electrode including: a nonwoven web-type polymer substrate having a carbon body bound to the surface thereof; and an electrode active layer on the polymer substrate.

According to an embodiment of the present disclosure, the polymer substrate may include an aromatic polymer, particularly, a polyetherimide-based polymer. In this case, the binding force of the polymer substrate surface to the carbon body may be further improved.

According to an embodiment of the present disclosure, the polymer substrate may include a polyetherimide-based polymer and a crosslinked polymer derived from a multifunctional monomer. In general, the polyetherimide-based polymer may be a commercially available polyetherimide (PEI), or may be prepared by directly carrying out a method including a step of reacting a dianhydride ingredient with a diamine ingredient in a suitable solvent to form polyamic acid (PAA) as a precursor and heating the precursor to perform imidization. For example, one of the polyetherimides described in Korean Patent Laid-Open No. 10-2015-0096428 A may be used, but the scope of the present disclosure is not limited thereto.

The crosslinked polymer may be one having a three-dimensional crosslinking structure prepared through the thermal polymerization or photopolymerization of a multifunctional monomer. The multifunctional monomer may include two or more reactive functional groups, which are one type of functional groups or at least two types of functional groups selected from the group consisting of acryl, methacryl, vinyl, thiol, epoxy, isocyanate, silanol, halogen, carboxyl, hydroxyl and amine groups. In addition, the multifunctional monomer may have a number average molecular weight of 100-2000 g/mol, particularly 100-1000 g/mol.

Non-limiting examples of the multifunctional monomer may include, but are not limited to: diglycidyl ether, trimethylolpropane triglycidyl ether, pentaerythritol polyglycidyl ether, benzyl glycidyl ether, triglycidyl isocyanurate, polyglycidyl ether, ethoxylated trimethylolpropane triacrylate (ETPTA), trimethylolpropane propoxylate triacrylate (TPPTA), pentaerythritol triacrylate (PETA), trimethylolpropane tris (3-mercaptopropionate (TMPT), trimethylolpropane triacrylate (TMPTA), pentaerythritol tetrakis (3-mercaptopropionate) (PEMP), dipentaerythritol hexakis (3-mercaptopropionate, or the like.

According to an embodiment of the present disclosure, the polymer substrate may have a semi-interpenetrating polymer (IPN) network structure. Particularly, the linear polyetherimide-based polymer and the crosslinked polymer derived from a multifunctional monomer may be mixed physically with each other to form a semi-interpenetrating polymer (IPN) network structure. In this manner, the thick film electrode according to an embodiment of the present disclosure includes the polymer substrate and an electrode active layer, and thus may be formed to have a large thickness without physical cracking and may show uniform and excellent electrical conductivity and excellent conductive material dispersibility in the thickness direction.

According to an embodiment of the present disclosure, the weight ratio of the polyetherimide-based polymer to the crosslinked polymer may satisfy 1-10:1, or 1.5-5:1.

According to an embodiment of the present disclosure, the polymer substrate may have a thickness of 1-100 μm, 5-50 μm, or 5-20 μm.

According to an embodiment of the present disclosure, when the polymer substrate has a thickness of 10±2 μm, it may have a weight per unit area of 0.05-2 mg/cm², or 0.1-1 mg/cm₂.

According to an embodiment of the present disclosure, the polymer substrate may have an electrical conductivity of 5-100 S/cm, or 10-50 S/cm.

According to an embodiment of the present disclosure, the polymer substrate may have a porosity of 10-90%, or 30-70%.

According to an embodiment of the present disclosure, the surface of the polymer substate may be bound to a carbon body, and particularly, the carbon body may be wrapped with the polymer substrate. More particularly, the carbon body may be bound to the polymer substrate by π electron interaction. Since the thick film electrode according to an embodiment of the present disclosure has a nonwoven web-type polymer substrate having a carbon body bound to the surface thereof, it preferably shows uniform conductive material distribution in the thickness direction and has excellent electron conductivity.

According to an embodiment of the present disclosure, the carbon body may be any one selected from carbon nanotubes, carbon nanofibers, graphene, reduced graphene oxide (rGO) and carbon black, or a combination thereof, and preferably may be carbon nanotubes. The carbon body may be any one selected from single-walled carbon nanotubes (SWCNTs), double-walled carbon nanotubes, multi-walled carbon nanotubes and rope carbon nanotubes, or a combination thereof, and preferably may be single-walled carbon nanotubes (SWCNTs). More particularly, the carbon body may be metallic single-walled carbon nanotubes (m-SWCNTs), semiconducting single-walled carbon nanotubes (sc-SWCNTs) or a mixture thereof.

According to an embodiment of the present disclosure, the electrode active layer may include a crosslinked polymer derived from a multifunctional monomer, an electrolyte, an active material and a conductive material.

According to an embodiment of the present disclosure, the crosslinked polymer may be a crosslinked polymer having a three-dimensional network structure and prepared by thermal curing or photocuring of a multifunctional monomer. Particularly, the multifunctional monomer may be a monomer containing at least two photocurable functional groups, wherein the photocurable functional group may be any one selected from the group consisting of acrylate, methacrylate, vinyl and thiol groups, or a combination thereof. Non-limiting examples of the multifunctional monomer may include, but are not limited to: ethoxylated trimethylolpropane triacrylate (ETPTA), trimethylolpropane propoxylate triacrylate (TPPTA), pentaerythritol triacrylate (PETA), or the like.

According to an embodiment of the present disclosure, the crosslinked polymer may be present in an amount of 3-80 parts by weight, 5-50 parts by weight, or 10-30 parts by weight, based on 100 parts by weight of the electrolyte.

According to an embodiment of the present disclosure, the crosslinked polymer may be present in an amount of 0.1-20 parts by weight, or 1-10 parts by weight, based on 100 parts by weight of the active material.

According to an embodiment of the present disclosure, the electrolyte may include an organic solvent and a lithium salt. The organic solvent may be a nonaqueous electrolyte, and non-limiting examples thereof may include carbonate-based, ester-based, ether-based, ketone-based, alcohol-based or aprotic solvents. Such solvents may be used alone or in combination, and the mixing ratio may be controlled with ease depending on desired battery performance. In addition, any organic solvent known to those skilled in the art may be used, but the scope of the present disclosure is not limited thereto. Further, in order to improve charge/discharge characteristics, flame resistance, or the like, the electrolyte may further include pyridine, triethyl phosphate, triethanolamine, cyclic ether, ethylene diamine, n-glyme, triamide hexaphosphate, nitrobenzene derivative, sulfur, quinone imine dye, N-substituted oxazolidinone, N,N-substituted imidazolidine, ethylene glycol dialkyl ether, ammonium salt, pyrrole, 2-mexhoxyethanol, aluminum trichloride, or the like, if necessary. Optionally, the electrolyte may further include a halogen-containing solvent, such as carbon tetrachloride, ethylene trifluoride, or the like, in order to impart non-flammability, and may further include fluoroethylene carbonate (FEC), propene sultone (PRS), fluoropropylene carbonate (FPC), or the like, in order to improve high-temperature preservation characteristics.

The lithium salt may be dissolved in the organic solvent and functions as a lithium-ion source in a battery, thereby allowing fundamental operation of a lithium secondary battery and accelerating lithium-ion migration between a positive electrode and a negative electrode. Non-limiting examples of the lithium salt may include LiPF₆, LiBF₄, LiSbF₆, LiAsF₆, LIN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) (wherein each of x and y represents a natural number), LiCl, Lil, LiB (C₂O₄)₂ or a combination thereof. The lithium salt may be used at a concentration ranging from 0.1 M to 5.0 M, or from 0.1 M to 2.0 M in the electrolyte.

According to an embodiment of the present disclosure, the active material may include any conventional positive electrode active material used in the art with no particular limitation, as long as it is a material capable of reversible lithium-ion intercalation and deintercalation. Non-limiting examples of the active material may include, but are not limited to: lithium cobalt composite oxide (LiCoO₂), spinel crystalline lithium manganese composite oxide (LiMn₂O₄), lithium manganese composite oxide (LiMnO₂), lithium nickel composite oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium composite oxide (LiNbO₂), lithium iron composite oxide (LiFeO₂), lithium magnesium composite oxide (LiMgO₂), lithium copper composite oxide (LiCuO₂), lithium zinc composite oxide (LiZnO₂), lithium molybdenum composite oxide (LiMoO₂), lithium tantalum composite oxide (LiTaO₂), lithium tungsten composite oxide (LiWO₂), lithium-rich manganese-rich nickel cobalt composite oxide (xLi₂MnO₃(1-x)LiMn1-y-zNiyCozO₂), lithium nickel cobalt aluminum composite oxide (LiNi_{0.8}Co_{0.15}Al_{0.05}O₂), lithium nickel cobalt manganese composite oxide (LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂), lithium nickel manganese oxide (LiNi_{0.5}Mn_{1.5}O₄), or the like.

According to an embodiment of the present disclosure, the conductive material may include: carbon black, such as acetylene black, ketjen black, channel black, furnace black, lamp black and thermal black; conductive fibers, such as carbon fibers and metal fibers; fluorocarbon; metal powder, such as aluminum and nickel powder; conductive whisker, such as zinc oxide and potassium titanate; conductive metal oxide, such as titanium oxide; conductive material, such as polyphenylene derivative; or the like. However, the conductive material is not particularly limited, as long as it has conductivity while not causing any chemical change in a battery. The conductive material may be used in an amount of 0.5-20 parts by weight based on 100 parts by weight of the active material.

According to an embodiment of the present disclosure, the electrode active layer may have a thickness of 10-500 μm, 30-400 μm, or 40-300 μm, but is not limited thereto.

The thickness of the electrode active layer may be controlled with ease depending on desired physical properties.

According to an embodiment of the present disclosure, the thick film electrode may have a structure in which at least two unit electrode active layers including a polymer substrate and an electrode active layer on the polymer substrate are stacked in the thickness direction. A thick film electrode may be obtained with no physical cracking by stacking the unit electrode active layers repeatedly. The thick film electrode may have a structure in which 2, 3, 4, 5, 6, 7, 8, 9, 10, at least 10, 2-15, or 4-12 unit electrode active layers are stacked, but is not limited thereto. The number of unit electrode active layers may be controlled with ease depending on physical properties to be obtained. Even when a plurality of the unit electrode active layers are stacked in the thickness direction in the thick film electrode according to an embodiment of the present disclosure, it is possible to stably provide the thick film electrode with uniform conductive material distribution in the thickness direction and excellent ion conductivity.

According to an embodiment of the present disclosure, the thick film electrode may have a weight of the active material per unit area (loading amount) of 5-200 mg/cm², 10-100 mg/cm², or 40-80 mg/cm². The thick film electrode according to an embodiment of the present disclosure has an advantage in that it has a significantly higher active material loading amount per unit area as compared to the related art.

According to an embodiment of the present disclosure, the thick film electrode may have a thickness of 50-1000 μm, 100-500 μm, or 200-450 μm. Even though the thick film electrode has such a large thickness, there are advantages in that the thick film electrode causes no physical cracking and has uniform conductive material distribution in the thickness direction.

According to an embodiment of the present disclosure, the thick film electrode may have a capacity per area (areal capacity) of 3 mAh/cm² or more, 6 mAh/cm² or more, 9 mAh/cm² or more, 10 mAh/cm² or more, or 12 mAh/cm² or more under the condition of 0.05 C/0.1 C in a voltage range of 3.0-4.4 V. The thick film electrode may show significantly higher areal capacity as compared to the values reported according to the related art.

According to an embodiment of the present disclosure, the thick film electrode may have a specific capacity, i.e. capacity per active material weight of 150 mAh/g or more, 170 mAh/g or more, or 180 mAh/g or more, under the condition of 0.05 C/0.05 C in a voltage range of 3.0-4.4 V.

In another aspect of the present disclosure, there is provided an electrochemical device including the above-described thick film electrode as a positive electrode. Particularly, the electrochemical device may include: a positive electrode including the above-described thick film electrode; and a negative electrode, and may optionally further include a separator interposed between the positive electrode and the negative electrode.

The positive electrode may include a positive electrode current collector and the above-described thick film electrode formed on the positive electrode current collector.

Non-limiting examples of the positive electrode current collector may include foil made of aluminum, nickel or a combination thereof, or the like. The positive electrode current collector may have a thickness of 3-500 μm, but is not limited thereto.

The negative electrode may include a negative electrode current collector and a negative electrode active material layer formed on the negative electrode current collector. Non-limiting examples of the negative electrode current collector may include foil made of copper, gold, nickel, copper alloy or a combination thereof, or the like. The negative electrode active material layer may include at least one selected from the group consisting of: carbon selected from soft carbon, hard carbon, artificial graphite, natural graphite, expandable graphite, carbon fibers, non-graphitizable carbon, carbon black, carbon nanotubes, acetylene black, ketjen black, graphene, fullerene, activated carbon and mesocarbon microbeads; metals selected from silicon, tin, lithium, aluminum, silver, bismuth, indium, germanium, lead, platinum, titanium, zinc, manganese, cadmium, selenium, copper, cobalt, nickel and iron; alloy including at least two of the metals; and oxides of at least one of the metals. Preferably, the negative electrode active material layer may include lithium metal, but is not limited thereto.

The separator has micropores through which ions may pass. Non-limiting examples of the separator may include any one selected from the group consisting of glass fibers, polyester, polyethylene, polypropylene and polytetrafluoroethylene, or a combination thereof, and the separator may be provided in the form of a nonwoven web or woven web. Particularly, a polyolefin-based polymer separator, such as polyethylene and polypropylene, may be used frequently, but the scope of the present disclosure is not limited thereto. In addition, a separator coated with a composition containing a ceramic ingredient or polymer material may be used in order to ensure heat resistance or mechanical strength, and such a separator may optionally have a monolayer or multilayer structure. Any separator known to the art may be used, but the scope of the present disclosure is not limited thereto.

The electrochemical device may be fabricated in a shape used currently in the art. There is no limitation in the outer shape of a battery depending on the use thereof. For example, the battery may have a cylindrical shape using a can, a prismatic shape, a pouch-type shape or a coin-like shape.

The electrochemical device may show a capacity per active material weight of 150 mAh/g or more, 170 mAh/g or more, or 180 mAh/g or more under the condition of 0.05 C/0.1 C in a voltage range of 3.0-4.4 V.

The electrochemical device may have an energy per weight of 200 Wh/g or more, 300 Wh/g or more, or 350 Wh/g or more. In addition, the electrochemical device may have an energy density of 500 Wh/L or more, 700 Wh/L or more, or 900 Wh/L or more. Herein, the weight is calculated including the parts forming a cell and packaging material and is a value measured under the condition of SOC=0%. In addition, the energy per weight (specific energy) and energy density are calculated with reference to a non-patent document (Park, S.-H. et al. High areal capacity battery electrodes enabled by segregated nanotube networks. Nat. Energy 4, 560-567 (2019).

Hereinafter, the method for manufacturing a thick film electrode according to an embodiment of the present disclosure will be explained in more detail.

In another aspect of the present disclosure, there is provided a method for manufacturing a thick film electrode, including the steps of: (S1) preparing a nonwoven web-type polymer substrate having a carbon body bound to the surface thereof; and (S2) applying a slurry composition containing a multifunctional monomer, an electrolyte, an active material and a conductive material onto the polymer substrate, followed by curing, to form an electrode active layer. Detailed description of the polymer substrate, carbon body, multifunctional monomer, electrolyte, active material, conductive material, electrode active layer and thick film electrode and examples of the compounds are the same as described above, and thus will be omitted hereinafter.

According to an embodiment of the present disclosure, step (S1) is a step of preparing a polymer substrate and may include the steps of: (a) electrospinning a mixed solution including a polyetherimide-based polymer and a multifunctional monomer-containing polymer; and (b) electrospraying a carbon body dispersion. Detailed description of the polymer substrate, carbon body, multifunctional monomer, electrolyte, active material, conductive material, electrode active layer and thick film electrode and examples of the compounds are the same as described above, and thus will be omitted hereinafter. Step (a) and step (b) are carried out preferably at the same time. In this manner, it is possible to obtain a nonwoven web-type polymer substrate having a carbon body bound to the surface thereof.

Particularly, in step (a), the mixed polymer solution may include a polyetherimide-based polymer, a multifunctional monomer and a solvent. The weight ratio of the polyetherimide-based polymer to the multifunctional monomer may satisfy 1-10:1 or 1.5-5:1. The mixed polymer solution may include the polyetherimide-based polymer and the multifunctional monomer in an amount of 0.1-80 wt % or 0.5-50 wt %, based on the total weight of the mixed polymer solution.

The solvent is not particularly limited, as long as it is a solvent capable of dissolving the polyetherimide-based polymer and the multifunctional monomer. The solvent may be a polar organic solvent, and non-limiting examples thereof may include any one selected from N-methyl-2-pyrrolidone, acetone, N,N-dimethylformamide (DMF), dimethyl sulfoxide (DMSO), cyclohexyl pyrrolidinone (CHP), N-dodecyl pyrrolidone (N12P), benzyl benzoate, N-octyl pyrrolidone (N8P), dimethyl imidazolidinone (DMEU), cyclohexanone and dimethyl acetamide (DMAc), or a combination thereof.

In addition, the mixed polymer solution may further include a known polymer initiator used widely in the art. The polymerization initiator may be a thermal initiator or a photoinitiator. Non-limiting examples of the thermal initiator may include: an azo-based initiator, such as 2,2-azobis-2,4-dimethylvaleronitrile, 2,2-azobisisobutyronitrile or 2,2-azobis-2-methylbutyronitrile; a peroxide-based initiator, such as amyl peroxypivalate, hexyl peroxy dicarbonate, benzoyl peroxide or dibenzoyl peroxide; or the like. The photoinitiator is not particularly limited, as long as it is a compound capable of generating radicals by the irradiation of active energy rays and initiating radical reaction. Non-limiting examples of the photoinitiator may include an alpha-ketone-based compound, acetophenone-based compound, ketal-based compound, aromatic sulfonyl chloride-based compound, photoactive oxime-based compound, benzophenone-based compound, thioxanthone-based compound, camphoroquinone-based compound, ketone halide-based compound, acyl phosphinoxide-based compound, acyl phosphonate-based compound, or the like.

The method for electrospinning a polymer mixed solution may be carried out through a known or conventional method. For example, the electrospinning may be carried out under the condition of 1-30 kV or 5-20 kV at an ejection rate of 0.1-10 μL/min or 0.5-5 μL/min, but is not limited thereto. In this manner, it is possible to obtain nanofibers containing including a polyether imide-based polymer and a multifunctional monomer, and a nonwoven web-type polymer substrate including the same.

Particularly, in step (b), the carbon body dispersion may include the above-described carbon body and a solvent, wherein the solvent is not particularly limited, as long as it allows dispersion of the carbon body therein. For example, the solvent may be at least one selected from water, isopropyl alcohol (IPA), ethanol, ethoxyethanol, butoxyethanol and N-methyl-2-pyrrolidone (NMP). Preferably, the solvent may be a mixture of IPA or ethanol with water, but is not limited thereto.

The method for electrospraying a carbon body dispersion may be carried out through a known or conventional method. For example, the electrospraying may be carried out under the condition of 5-50 kV or 10-30 kV at a spraying rate of 5-200 μL/min or 10-100 μL/min, but is not limited thereto. In this manner, it is possible to obtain a nonwoven web-type polymer substrate having a carbon body bound to the surface thereof.

According to an embodiment of the present disclosure, step (S2) may further include a step of carrying out thermal polymerization or photopolymerization to polymerize the multifunctional monomer of the mixed polymer solution. The thermal curing may be carried out through heating at a temperature of 60° C. or higher, preferably 80° C. or higher for a predetermined time. In addition, the photocuring may be carried out by irradiating a light source in an ultraviolet ray (UV) wavelength range. For example, the substrate may be irradiated with a lamp in a UV wavelength range of 254 nm, 300 nm, 365 nm, 385 nm or 395 nm, or 1260 mW/cm² Hg UV lamp, but the scope of the present disclosure is not limited thereto. In this manner, the multifunctional monomer is polymerized to form a crosslinked polymer, and the linear polyetherimide-based polymer and the crosslinked polymer derived from the multifunctional monomer are physically mixed to provide a nonwoven web-type polymer substrate including a carbon body bound to the surface thereof and having a semi-interpenetrating polymer network (semi-IPN) structure.

According to an embodiment of the present disclosure, step (S2) may further include a step of applying pressure at a temperature of 60° C. or higher, preferably 80° C. or higher, for a predetermined time. This may be carried out by using a conventional roll pressing method. In this manner, it is possible to obtain a polymer substrate having higher adhesive property.

Particularly, in step (S2), the slurry composition may include a multifunctional monomer, an electrolyte, an active material and a conductive material. For example, a polymer electrolyte precursor including the multifunctional monomer mixed with the electrolyte is prepared first, and then the active material and the conductive material are introduced to the polymer electrolyte precursor to provide a slurry composition. However, the scope of the present disclosure is not limited thereto. More particularly, the weight ratio of the multifunctional monomer to the electrolyte may satisfy 1:1-20, preferably 1:2-10. In addition, the weight ratio of the polymer electrolyte precursor to the active material may satisfy 1:0.5-20, preferably 1:1-7.

The method for applying the slurry composition may include a currently used or known application or coating method. For example, a knife casting, tape casting, bar coating or stencil-printing method may be used, but the scope of the present disclosure is not limited thereto. Then, the method for curing the coated slurry composition is the same as the thermal curing or photocuring step of the above-described (S1), and thus description thereof will be omitted. In this manner, it is possible to form an electrode active layer on the polymer substrate.

According to an embodiment of the present disclosure, the polymer substrate having an electrode active layer and obtained through a unit process including steps (S1) and (S2) once may be used as a unit electrode active layer, and the unit process may be carried out many times to obtain a thick film electrode having multiple unit electrode active layers. However, when carrying out the unit process repeatedly, step (S1) may be substituted with a step of disposing the resultant polymer substrate on the electrode active layer from the second time, instead of preparing a polymer substrate. Particularly, the method may further include subjecting the electrode active layer on the polymer substrate to the unit process including steps (S1) and (S2) repeatedly at least once, once, twice, three times, four times, five times, six times, seven times, eight times, nine times, ten times, or at least ten times. In this manner, it is possible to obtain a thick film electrode in which a plurality of the unit electrode active layers are stably stacked without physical cracking of the surface and the conductive material distribution is uniform in the thickness direction.

The method for manufacturing a thick film electrode according to an embodiment of the present disclosure may further include a step of applying pressure of 1 MPa or more, preferably a pressure of 3-10 MPa, to the thick film electrode obtained through the above-described method for a predetermined time. In this manner, it is possible to obtain a thick film electrode having higher durability.

Examples will be described more fully hereinafter with reference to the accompanying drawings so that the present disclosure can be understood with ease. The following examples may, however, be embodied in many different forms and should not be construed as limited to the exemplary embodiments set forth therein.

### [Preparation Example 1] Preparation of Nonwoven Web-Type Substrate

Polyetherimide (PEI) powder and trimethylolpropane propoxylate triacrylate (TPPTA) were dissolved in a mixed solvent (N-methyl-2-pyrrolidne (NMP)/dimethylacetamide (DMAc)=25/75 (w/w)) at a weight ratio of 7:3 to prepare a polymer solution for electrospinning. In addition, 1 wt % of benzoyl peroxide (BPO) was further introduced as a thermal initiator at a ratio of 1 wt % based on TPPTA.

In addition, prepared was a carbon body dispersion for electrospraying, containing single-walled carbon nanotubes (SWCNTs) (TUBALL™) dispersed in a mixed solvent (water/IPA=9/1 (w/w)) at a ratio of 1 wt %.

The resultant polymer solution for electrospinning was subjected to electrospinning at 11 KV and an ejection rate of 3 μL/min, while the carbon body dispersion was subjected to electrospraying through another nozzle at 14 KV and an ejection rate of 60 μL/min at the same time. Then, thermal polymerization was carried out at 90° C. for 3 hours and roll pressing was carried out at 80° C. and a rate of 1 m/min with a pressing ratio of 10%. Finally, a nonwoven web-type polymer substrate (referred to as ‘polymer substrate’ hereinafter) having a carbon body bound to the surface thereof and having a thickness of about 11 μm was obtained.

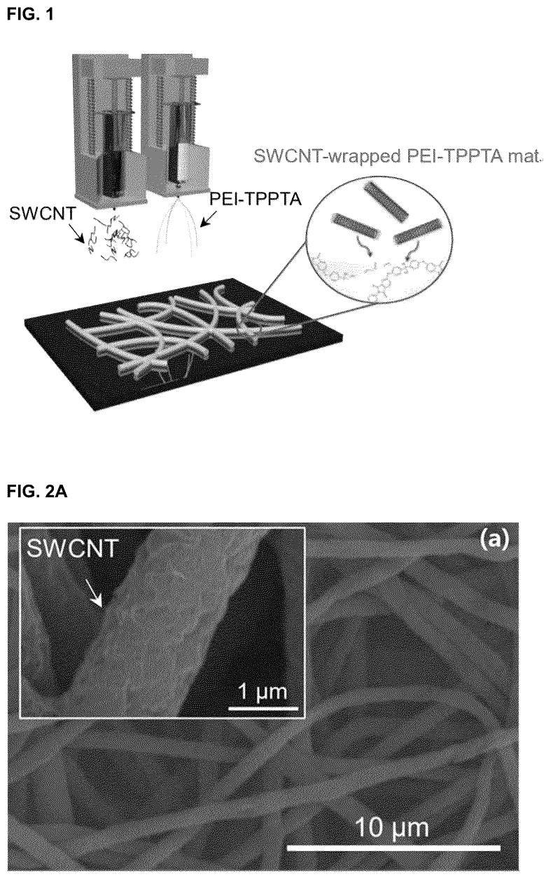

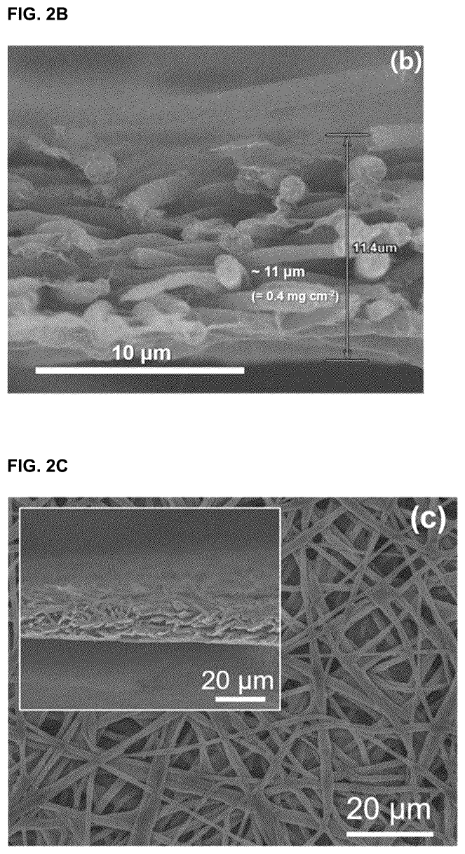

FIG. 1 is a schematic view illustrating the above-described Preparation Example, and FIG. 2A and FIG. 2B illustrate the scanning electron microscopic (SEM) images of the resultant nonwoven web-type polymer substrate.

### [Preparation Example 2] Preparation of Nonwoven Web-Type Substrate

A nonwoven web-type polymer substrate was obtained in the same manner as Preparation Example 1, except that trimethylolpropane triacrylate (TMPTA) was used as a multifunctional monomer, instead of trimethylolpropane propoxylate triacrylate (TPPTA). FIG. 2C is an SEM image of the resultant nonwoven web-type polymer substrate.

### [Preparation Example 3] Preparation of Nonwoven Web-Type Substrate

A nonwoven web-type polymer substrate was obtained in the same manner as Preparation Example 1, except that ethoxylated trimethylolpropane triacrylate (ETPTA) was used as a multifunctional monomer, instead of trimethylolpropane propoxylate triacrylate (TPPTA). FIG. 2D is an SEM image of the resultant nonwoven web-type polymer substrate.

### Example 1

A multifunctional monomer (ethoxylated trimethylolpropane triacrylate (ETPTA)) and nonaqueous electrolyte (1 M LiPF₆ in ethylene carbonate (EC)/propylene carbonate (PC) (1/1 (v/v)) were mixed at a weight ratio of 15:85 to prepare a polymer electrolyte precursor. Herein, a photoinitiator was introduced at 0.1 wt % based on the total weight of the polymer electrolyte precursor.

A slurry composition including a mixture containing the polymer electrolyte precursor, an active material (NCM811) and a conductive material (carbon black, Super C65) at a weight ratio of 20:75:5 was applied to the polymer substrate obtained from one of the above-described Preparation Examples by using a stencil-printing method. Then, another polymer substrate of the preparation example was stacked on the polymer substrate coated with the slurry composition, and a 1260 mW/cm² Hg UV lamp (Lichtzen) was irradiated thereto at an interval of 5 cm to carry out photocuring. The above procedure was repeated six times, and pressing was carried out at a pressure of 5 MPa to obtain a thick film electrode having a thickness of 315 μm and an active material loading amount of 60 mg/cm².

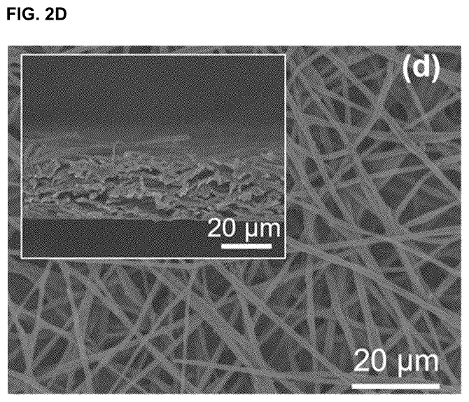

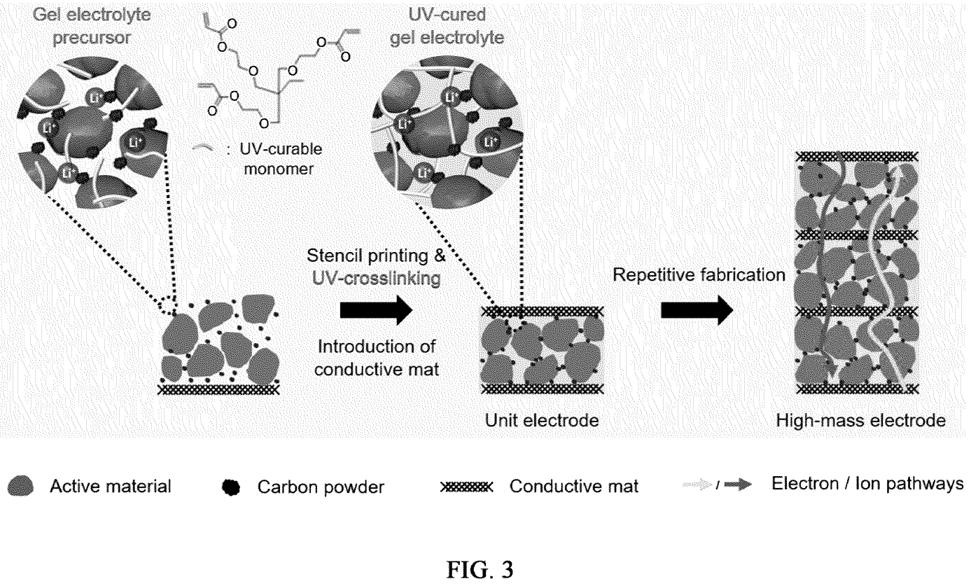

FIG. 3 is a schematic view illustrating the approximate process of Example 1, and FIG. 4 shows an image of the resultant thick film electrode and an SEM image of the thick film electrode.

### Examples 2-5

A thick film electrode was obtained by repeating the procedure of Example 1 five times, twice, once or zero (0) times, instead of six times. The thickness and active material loading amount of each thick film electrode are shown in the following Table 1.

### Comparative Example 1

A slurry mixture (NCM811/polyvinylidene fluoride (PVDF)/carbon black=92/4/4 (w/w/w) in NMP) having a solid content of 60 wt % was applied to Al foil to a thickness of about 300 μm and vacuum-dried at 120° C. for 12 hours. Finally, a thick film electrode having a thickness of 180 μm and an active material loading amount of 38 mg/cm² was obtained.

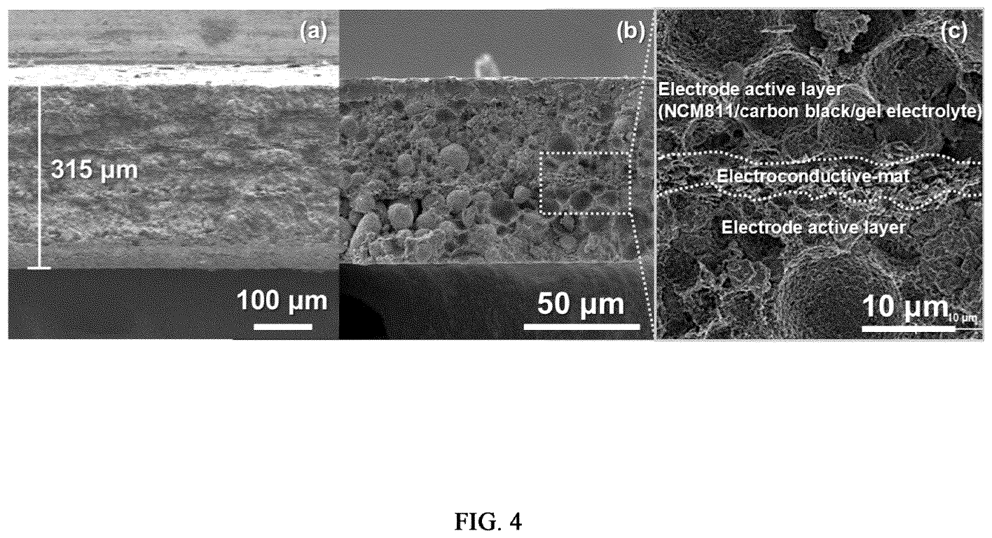

FIG. 5 is a schematic view illustrating the approximate process of Comparative Example 1.

TABLE 1

| | | Active material loading |
|---|---|---|
| | Thickness (μm) | amount (mg/cm²) |
| Ex. 1 | 315 | 60 |
| Ex. 2 | 220 | 51 |
| Ex. 3 | 160 | 36 |
| Ex. 4 | 100 | 23 |
| Ex. 5 | 60 | 16 |
| Comp. Ex. 1 | 180 | 38 |

### [Test Example 1] Structural Analysis

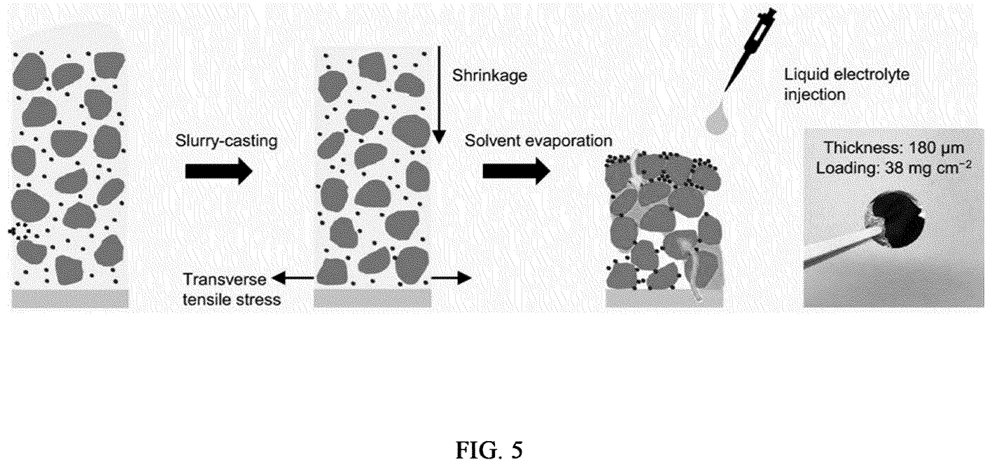

FIG. 6 is a graph illustrating the distribution of the conductive material in the thick film electrode according to each of Example 3 and Comparative Example 1 as visualized by using FIB 3D reconstruction (Image-Pro Premier 3D (Media Cybernetics)). As shown in FIG. 6, the electrode according to Comparative Example 1 shows non-uniform distribution of conductive material, while the thick film electrode according to Example 3 shows uniform distribution of conductive material. In addition, based on FIG. 6, the volume fraction of conductive material contained in each of the bottom portion (Vf_{bottom}), middle portion (Vf_{middle}) and the top portion (Vfₜₒₚ) was calculated, wherein 20% of the electrode length was taken as the bottom portion, 40% of the electrode length was taken as the medium portion and the remaining 40% of the electrode length was taken as the top portion, as viewed in the vertical direction from the bottom. The results are shown in the following Table 2.

### [Test Example 2] Electrochemical Performance

In Table 2, the electrical conductivity of the thick film electrode according to each of Example 3 and Comparative Example 1 is shown, as determined by using the four-point probe technique (CMT-SR1000N, Advanced Instrument Tech). In addition, the nonwoven web-type polymer substrate according to Preparation Example 1 is determined to have an electrical conductivity of 25 S/cm.

TABLE 2

| | Ex. 3 | Comp. Ex. 1 |
|---|---|---|
| (Vf_{bottom}) | 38 | 19 |
| (Vf_{middle}) | 36 | 28 |
| (Vfₜₒₚ) | 42 | 59 |
| Electrical conductivity [S/cm] | 2.3 | 0.3 |

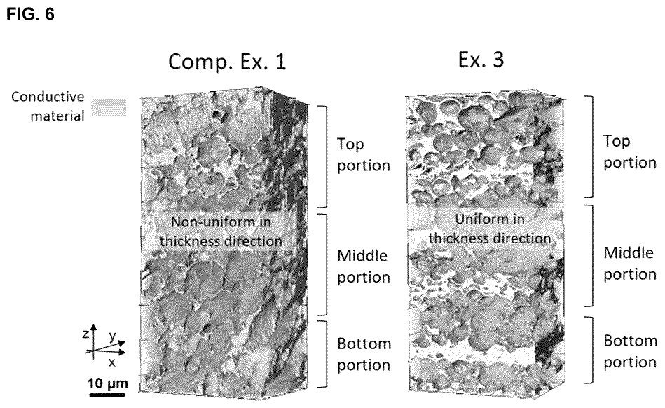

It can be seen from Table 2 that the thick film electrode according to Example 3 can be obtained in such a manner that it allows uniform distribution of conductive material despite its large thickness and also shows excellent electrical conductivity. In addition, FIG. 7 shows a sectional SEM image of the thick film electrode according to each of Comparative Example 1 and Example 3 and a graph illustrating the localized charge transfer resistance (R_{l,ct}) of each thick film electrode as analyzed by localized electrochemical impedance spectroscopy (LEIS). The scan range of LEIS was analyzed by using a work station (M470, Biologic) under the condition of a fixed frequency of 50 Hz, amplitude of 100 mV of an interval of 10 mm and an interval of 10 μm. It can be seen from FIG. 7 that the thick film electrode according to Example 3 shows uniform ion transfer resistance, which suggests that the redox reaction of the electrode can be performed uniformly even in the thickness direction.

### [Test Example 3] Performance of Inhibiting Ni Elution

A thick film electrode having an active material loading amount of 36 mg/cm² was prepared by the method of each of Example 1 and Comparative Example 1, and the thick film electrode was dipped in 0.01 M NiCl₂ aqueous solution for 3 hours. Then, the Ni content was determined through inductively coupled plasma-mass spectroscopy (ICP-MS) by using ELAN DRC-II analyzer available from Perkin Elmer. As a result, Example 1 shows an Ni content of 32.9 ppm, while Comparative Example 1 shows an Ni content of 97.8 ppm. This suggests that the thick film electrode according to the present disclosure can effectively inhibit Ni elution in the active material.

### [Test Example 4] Battery Performance, Life Characteristics and Rate Characteristics

The thick film electrode obtained from Test Example 3 and having an active material loading amount of 36 mg/cm² according to each of Example 1 and Comparative Example 1 was used as a negative electrode and lithium metal having a thickness of 100 μm was used as a positive electrode (capacity per area: 20 mAh/cm²). In addition, a polyethylene-based porous polymer separator was interposed between the positive electrode and the negative electrode, and an electrolyte containing 1 M LiPF₆ dissolved in a mixed solvent including ethylene carbonate (EC) and ethylmethyl carbonate (EMC) at a volume ratio of 30:70 and further including 1 wt % of fluoroethylene carbonate (FEC) and 1 wt % of vinylene carbonate (VC) was injected thereto to obtain a CR2023 coin cell (n/p ratio=2.8).

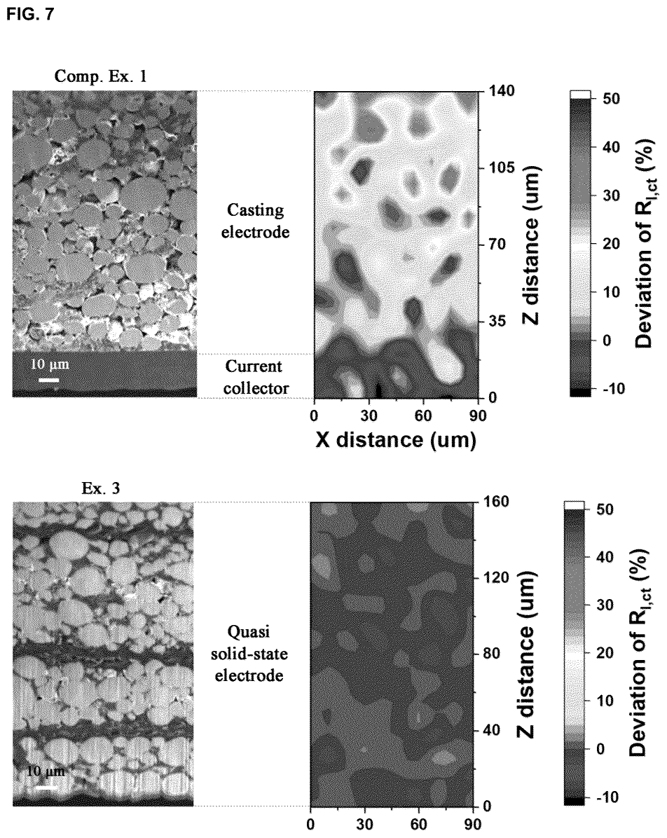

The coin cells were compared with each other in terms of charge/discharge rate performance under room temperature (25° C.) and different current conditions ((0.05 C/0.05 C (=0.35 mA/cm²) to 0.5 C/0.5 C (=3.5 mA/cm²)), and the resultant charge/discharge profile graph is shown in FIG. 8. Referring to FIG. 8, Example 1 can provide a specific discharge capacity of 191 mAh g NCM811-1, which is similar to the theoretical capacity (˜192 mAh g NCM811⁻¹) of NCM811 at 0.05 C. On the other hand, Comparative Example 1 shows a discharge capacity of 168 mAh g NCM811⁻¹ at 0.05 C. It can be seen from the above results that the thick film electrode according to an embodiment of the present disclosure shows a higher specific capacity (capacity per active material weight) even under the same active material loading amount. This suggests an advantageous effect of the thick film electrode according to Example 1 in terms of redox dynamics of a cell.

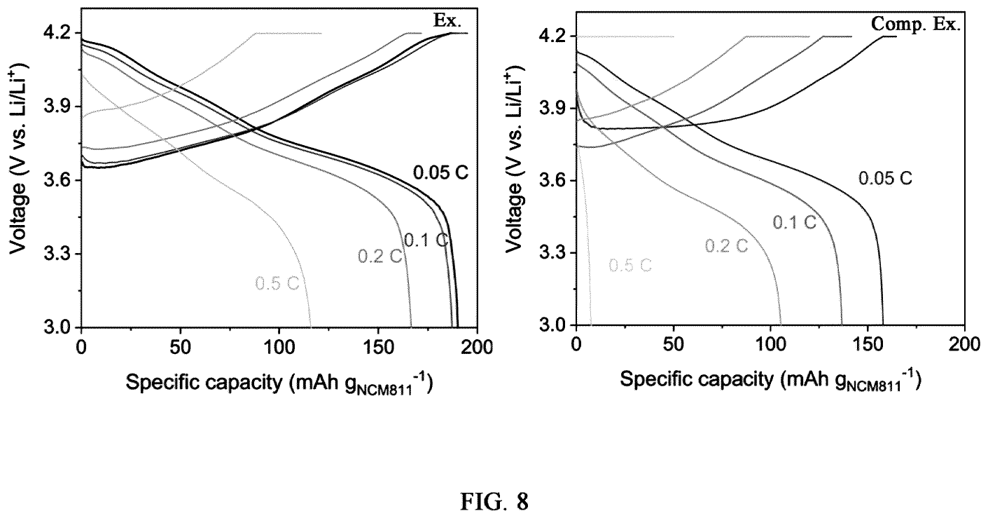

In addition, FIG. 9 is a graph illustrating the capacity per weight and coulombic efficiency of the same coin cell depending on charge/discharge cycle numbers under the condition of room temperature (25° C.) and 0.05 C/0.1 C (=0.35 mA/cm²/0.7 mA/cm²) in a voltage range of 3.0-4.2 V. As shown in FIG. 9, Example 1 shows a capacity retention of 90% even after the 80^{th} cycle, but Comparative Example 1 shows a capacity retention of 16%. It can be seen from the above result that the battery including the thick film electrode according to an embodiment of the present disclosure maintains a high capacity retention even after repeating charge/discharge cycles many times and provides excellent life characteristics.

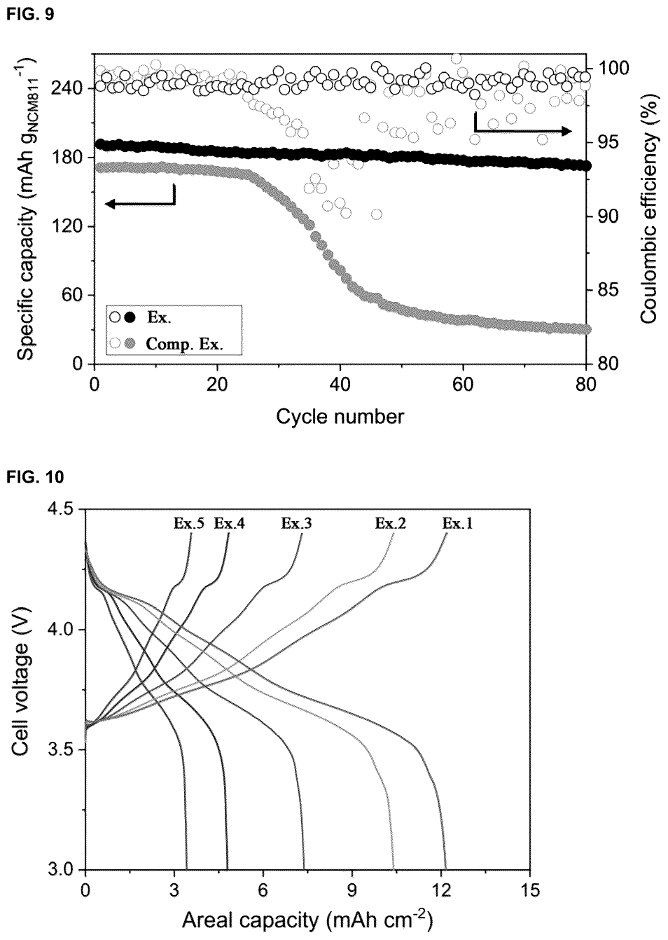

Further, the thick film electrode according to each of Examples 1-5 was used as a positive electrode to obtain a coin cell in the same manner as Test Example 4. The coin cell was subjected to a charge/discharge test under the condition of room temperature (25° C.) and 0.05 C/0.1 C in a voltage range of 3.0-4.4 V. The charge/discharge profile graph is shown in FIG. 10. Referring to FIG. 10, Example 1 shows a significantly high areal capacity of 12.3 mA/cm².

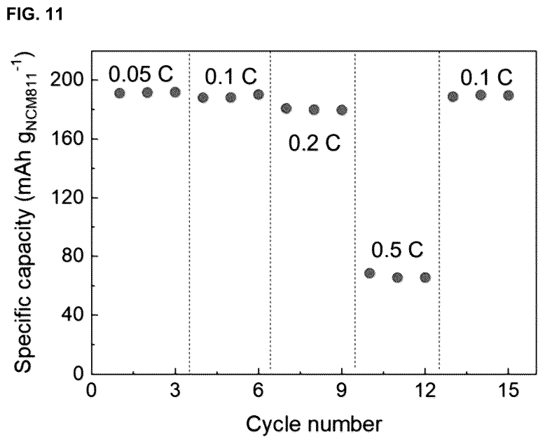

In addition, a cycle test was repeated many times at a charging rate of 0.05 C in a voltage range of 3.0-4.4 V with a variable current density of 0.05 C, 0.1 C, 0.2 C and 0.5 C in order to evaluate the rate characteristics of the coin cell using the thick film electrode according to Example 1. The results are shown in FIG. 11.

Further, it is shown that the coin cell using the thick film electrode according to Example 1 provides a high energy density (energy per weight (specific energy): 404 Wh·kg⁻¹, energy density: 1025 Wh·L⁻¹, calculated except the packaging material) under the cell fabricating condition (E/C ratio=2.3 g·Ah⁻¹, n/p ratio=1.6, 3.0-4.4 V, 25° C.).

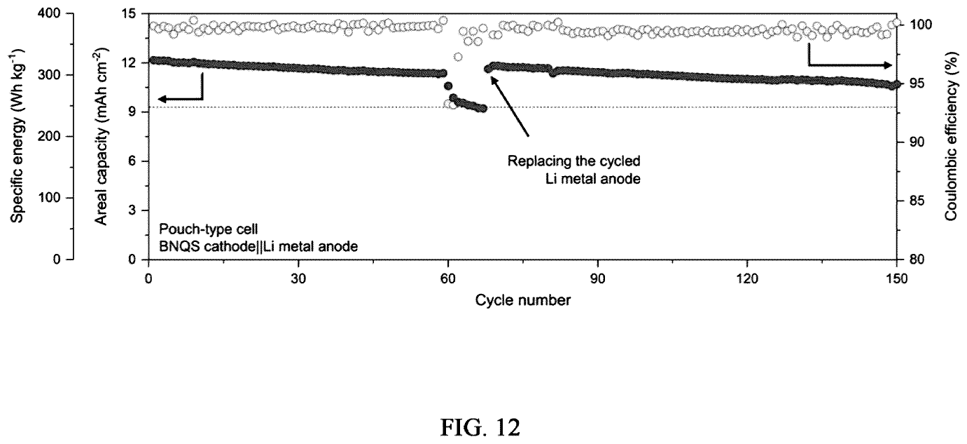

In addition, the thick film electrode according to Example 1 was used to obtain a pouch-type cell having a weight of 566 mg and a thickness of 589 μm. The cell fabricating method and materials are the same as the coin cell of Test Example 4, and description thereof will be omitted herein. The pouch-type cell was subjected to a charge/discharge test many times under the condition of room temperature (25° C.) and 0.05 C/0.1 C up to a voltage of 3.0 V. FIG. 12 is a graph illustrating the energy per weight (specific energy, Wh·kg⁻¹), areal capacity (mAh·cm⁻²) and coulombic efficiency (%) of the pouch-type cell depending on charge/discharge cycle numbers. Herein, at the 65^{th} cycle during the test, the lithium metal positive electrode was exchanged, and then the test was further carried out to the 150^{th} cycle. Particularly, it can be seen from FIG. 12 that the battery according to Example 1 shows high battery performance and excellent life characteristics even after the 150^{th} cycle.

Further, the pouch-type cell using the thick film electrode according to Example 1 provides a high energy density (energy per weight (specific energy): 321 Wh·kg⁻¹, energy density: 772 Wh·L⁻¹, calculated except the packaging material, SOC=0%) under the cell fabricating condition (E/C ratio=2.3 g·Ah⁻¹, n/p ratio=1.6, up to 3.0 V, 25° C.).

As can be seen from the foregoing, the thick film electrode according to an embodiment of the present disclosure can be obtained with no physical cracking despite its large thickness and provides uniform and excellent ion conductivity in the thickness direction and significantly high areal capacity, and thus the battery including the thick film electrode can provide high battery performance, high charge/discharge efficiency, excellent life characteristics and high energy density.

The present disclosure has been described in detail with reference to specific examples. However, it should be understood that the detailed description and specific examples are given by way of illustration only, and the scope of the present disclosure is not limited thereto, since various changes and modifications within the scope of the disclosure will become apparent to those skilled in the art from this detailed description.

Therefore, the scope of the present disclosure is not limited to the embodiments described herein, and not only the following claims but also equivalents and modifications thereof are also included in the scope of the present disclosure.

What is claimed is:

1. A thick film electrode comprising: a nonwoven web-type polymer substrate having a carbon body bound to the surface thereof; and an electrode active layer on the polymer substrate.

2. The thick film electrode according to claim 1, wherein the carbon body is bound to the polymer substrate by IT electron interaction.

3. The thick film electrode according to claim 1, wherein the carbon body is single-walled carbon nanotubes (SWCNTs).

4. The thick film electrode according to claim 1, wherein the polymer substrate has a semi-interpenetrating polymer (IPN) network structure.

5. The thick film electrode according to claim 1, wherein the electrode active layer comprises a crosslinked polymer derived from a multifunctional monomer, an electrolyte, an active material and a conductive material.

6. The thick film electrode according to claim 5, wherein the crosslinked polymer is present in an amount of 0.1-20 parts by weight based on 100 parts by weight of the active material.

7. The thick film electrode according to claim 1, wherein the polymer substrate comprises a polyetherimide-based polymer and a crosslinked polymer derived from a multifunctional monomer.

8. The thick film electrode according to claim 7, wherein the weight ratio of the polyetherimide-based polymer to the crosslinked polymer satisfies 1-10:1.

9. The thick film electrode according to claim 1, wherein the polymer substrate has a thickness of 1-100 μm.

10. The thick film electrode according to claim 1, which has a structure in which at least two unit electrode active layers comprising a polymer substrate and an electrode active layer on the polymer substrate are stacked in the thickness direction.

11. The thick film electrode according to claim 1, which has a weight of active material per unit area of 40-80 mg/cm².

12. The thick film electrode according to claim 1, which has a thickness of 100-500 μm.

13. A method for manufacturing a thick film electrode, comprising the steps of:
(S1) preparing a nonwoven web-type polymer substrate having a carbon body bound to the surface thereof; and
(S2) applying a slurry composition containing a multifunctional monomer, an electrolyte, an active material and a conductive material onto the polymer substrate, followed by curing, to form an electrode active layer.

14. The method for manufacturing a thick film electrode according to claim 13, wherein step (S1) comprises the steps of: (a) electrospinning a mixed polymer solution including a polyetherimide-based polymer and a multifunctional monomer-containing polymer; and (b) electrospraying a carbon body dispersion.

15. The method for manufacturing a thick film electrode according to claim 13, wherein the multifunctional monomer is a monomer containing at least two photocurable functional groups.

16. The method for manufacturing a thick film electrode according to claim 13, which further comprises repeating a unit process comprising steps (S1) and (S2) at least once.
